(19) United States
(12) Patent Application Publication
(10) Pub. No.: US 2010/0038149 A1
(43) Pub. Date: Feb. 18, 2010

(54) Device and System for Calculating and displaying the Calories in a Meal by a Built In Weigh-Scale and Computer Program in a Kitchen Plate or a Spoon

(76) Inventor: ELLA COREL, Petach Tikva (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/541,974

(22) Filed: Aug. 17, 2009

Related U.S. Application Data
(60) Provisional application No. 61/089,569, filed on Aug. 18, 2008.

(51) Int. Cl. G01G 19/40

(52) U.S. Cl. 177/25.16

(57) ABSTRACT

A system for calculating the calories in a meal by a kitchen plate or spoon with a built in weigh-scale and dedicated software to support a computer program for calculating the number of calories in a meal or portions of the meal according to the weight of specific kind of food. The program might calculate the number of calories in every bite, specific kind of food, and or the whole meal, remembering this information and providing it with accordance to the wishes and needs of the user.

### FIELD OF THE INVENTION

This invention is in the field of kitchenware and in particular a plate or a spoon with a built in weigh-scale and computer program that calculates the calories of the meal according to its weight.

### BACKGROUND OF THE INVENTION

The connection between overweight and a large number of diseases has already been proven and been penetrated to the awareness of all ages in the population all over the world. People today are much more concern with eating healthy and keeping on a balance diet, also many people who suffer from overweight trying to lose their overweight. There are many kinds of different diets. One of the most popular and effective diet is counting calories and eating the number of calories needed to the person according to his height, weight, age and sex.

This awareness of counting calories brought to a situation that most, if not all, of the products sold by food manufacture companies contain the number of calories of the products on the packages. Therefore, many people that are on diet have a small weigh scale in their kitchen to weight the food before they eat for calculating the calories in every meal.

To ease this process of weighting every specific kind of food, calculating its calories and adding it to the other kind of food, what is needed is a built in system for weighting and calculating the calories in a whole meal or even few meals.

### SUMMARY OF THE INVENTION

It is to be understood that both the foregoing general description and the following detailed description present embodiments of the invention and are intended to provide an overview or framework for understanding the nature and character of the invention as it is claimed.

This invention reveals a system for calculating the calories of a whole meal by a plate with built in weigh scale and dedicated software of a computer program to transfer the weight of specific kinds of food to calories.

This invention requires a person only to place the food he plans to eat on the plate and to press a button for entering the kind of food to the computer, the computer program then would automatically do all the calculations according to the kind of food and its weight. If there are few different kinds of dishes, this person would need to enter the computer the kind of food with each kind of food that he placed on the plate, the computer would calculate the calories of each kind of food separate and then would add all the calculation to one total result.

The results of the number of calories of the total meal or after each kind of food might be provided on a digital screen attached to the plate or might be provided vocally by an attached audio speaker.

There might be a further possibility that if the person did not finish his meal, the computer would estimate the calories of the remaining or/and the calories of the food that the person actual ate.

The computer would have a memory card and might have an option for remembering the calories of previous meals for calculation the total calories that the person ate for the last day, week, or even a month with the average of calories being consumed for a day.

Additional programs might be added so the computer after being provided with the required data of the user, i.e. sex, age, height and weight, might provide a program or advices for a preferred diet of that person. The computer program further with that data on the user and the calories of the meals that have been eaten might provide reports on the diet and even recommendations for continuing the diet. The computer might also be programmed to provide alert when the number of calories are over the suggested or planed by the user. The alert might be for example a red light or flashes of lights on the digital screen, or might be even a vocal alert with sentences that would remind and encourage the person to continue his diet and the importance in it.

The source of power for the weigh-scale and the computer to work might be a battery, external connection to electrical source, solar energy, or even might be a combination of the above.

There might also be a USB connection to connect the plate to an external computer for download different information or programs for diets, or even for providing power source and charging the battery of the plate.

Additional features might be added to the plate as for example additional weigh-scale and a dedicated place for a glass for calculating also the calories of different drinks and adding them to the calculation of the calories of the meals. This system of calculating the calories in a meal might also be implemented on a spoon or even a fork calculating the calories of every bite, by providing the kind of food placed on the spoon and weighting it, and adding to the total calculation to provide a person with the information of how many calories he ate and when he reaches the amount he needs to eat by a vocal or visual alert.

### BRIEF DESCRIPTION OF THE DRAWINGS

The accompanying drawings are included to provide a further understanding of the invention and are incorporated into and constitute a part of this specification. The drawings illustrate various embodiments of the invention and, together with the description, serve to explain the principles and operations of the invention, by way of example only and not to limit the invention to these descriptions only.

FIG. 1 is a schematic diagram of the kitchen plate with a build in weigh scale and computer program to calculate the number of calories in a given meal.

FIG. 2 is a schematic diagram of a cross sectional view of the kitchen plate with a build in weigh scale and computer program to calculate the number of calories in a given meal.

FIG. 3 is a schematic diagram of the kitchen plate with a build in weigh scale and computer program to calculate the number of calories in a given meal with additional optional features.

FIG. 4 is a schematic diagram of the kitchen spoon with a build in weigh scale and computer program to calculate the number of calories in a given meal.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

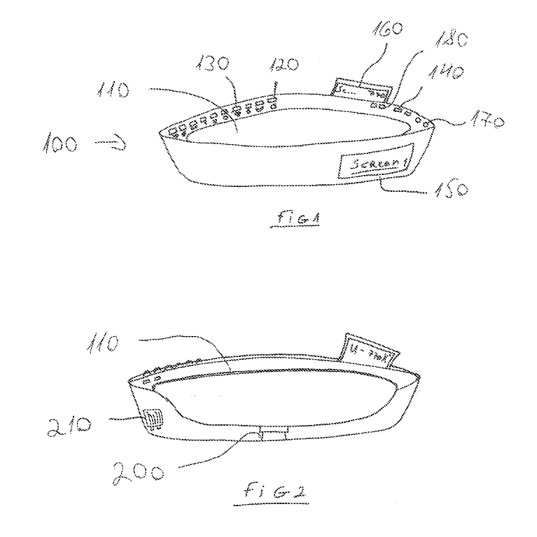

FIG. 1 shows the kitchen plate 100 with a build in weigh scale and a computer program to calculate the number of calories in a given meal.

The plate 100 enables a person to place inside the plate 110 any kind of food that he plans to eat and to only press the button identifying that food. For example if it is a tomato it would be button 120, if it is rice it would be button 130 and etc, if on the other hand he wants to eat something not regular he might insert the number of calories of the food for example for 100 grams of that food by a dedicated button 140. Another option of the present invention is to enable placement of a one time disposable plate or any ordinary plastic or glass plate onto the plate 110 to avoid the dirt of the plate 110 in every single use.

There are two alternate ways for calculating the food in the plate, one would be pressing on the buttons identifying the kind of food before placing the food on the plate, and the second would be pressing the buttons after the food has been placed on the plate. In both ways the computer would automatically calculate the exact weight of that specific food by either resetting the plate before adding the food or by reducing the previous weight that was before the food was added if adding the food and then pressing the button or by subtract the amount of each spoon loaded with food taking out from the plate respectively to the total amount or calories. Then the computer would automatically calculate the exact number of calories of that kind of food according to its weight and kind. The computer would then provide the calories after every added kind of food, first the calories of that kind and then the calories of all the food that is on the plate, providing in the end the calories of the whole meal. The outcomes of the calories would be provided on a digital screen that might be a built in screen 150 that would be attached on the side of the plate or might be a foldable screen 160 attached on the upper part of the plate for easier view.

There would also be an operation button 170 for turning on and off the computer and weigh-scale and for resetting. Additional buttons 180 might be added for different uses of the computer programs as providing personal dada on the user, asking diet programs, recommendations or any other optional information as discussed in the specification.

FIG. 2 shows the hidden weigh scale 200 that is placed underneath the surface that the food is placed on 110. This weigh-scale provides the computer with the needed information of the accurate weight of the food for calculating the number of calories for that food. The hardware 210 of the computer with the dedicated software would also be hidden inside the plate.

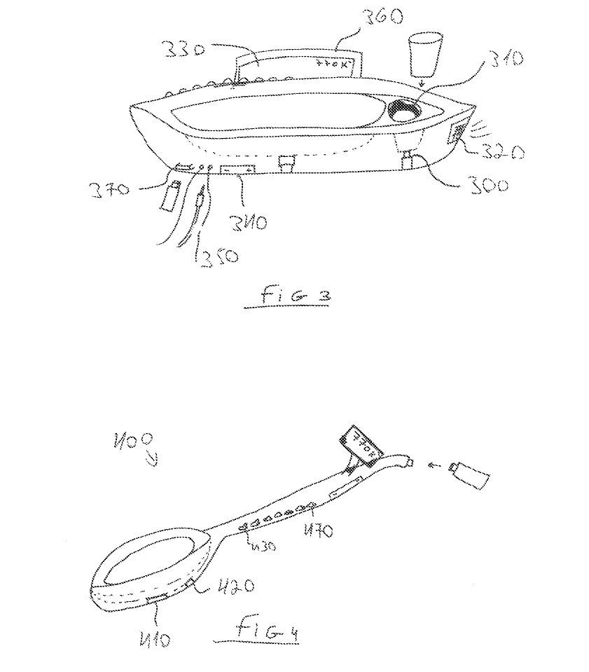

FIG. 3 shows different optional features that might be added to the plate with the build in weigh scale and computer program to calculate the number of calories in a given meal. An additional weigh-scale 300 might be added to weight the amount of drinks that the person drinks with the meal. A dedicated place for a glass 310 would also be added so the computer in the plate would also calculate the calories of different drinks and would add them to the calculation of the calories of the meals.

A speaker 320 might also be added for providing vocal information with addition to the information being display in the screen 330. The speaker 320 might also be used for alerting the user when he passes the number of calories suggested or planed according to the program of his diet. The alert might be by recorded audio providing sentences that would remind and encourage the user to continue his diet and the importance in it. The alert might also be displayed on the screen 330 with red light or flashes of lights for example.

The plate would also include a source of power for the weigh-scale and the computer to work. That source of power might be a battery 340, external connection to electrical source 350, solar energy 360, or even might be a combination of the above. A USB connection 370 might also be added to connect the plate to an external computer for download different information or programs for diets, or even for providing power source and charging the battery of the plate.

FIG. 4 shows a spoon 400 with a build in weigh scale 410 and computer program 420 to calculate the number of calories in a given meal.

The user would placed the food in the spoon and press one of the buttons 430-470 for identifying this kind of food or the amount of calories in that food in a 100 gram, the computer then automatically calculate according to the weight and the kind of food the number of calories in that spoon and would save that data. In every time the user fills the spoon he would need to press a button to calculate the number of the calories and also to add it the amount of calories that he already ate. When the user reaches the amount he needs to eat a vocal or visual alert might be given to him.

What is claimed:

1. apparatus and system for calculating the calories of a meal by a plate with built in weigh scale and dedicated software of a computer program, comprising:
a system for calculating the calories of a meal by a plate with built in weigh scale and dedicated software of a computer program to transfer the weight of each specific kinds of food on the plate or each specific kinds of food taking out of the plate, to calories and to sum it in the present time to the total sum,
wherein, the calculation of the system is by the computerized section of the system that is dedicated with software's and weigh-scale, whereby, in any time that the user is eating some amount of food, by taking that amount of and out of the plate of the present invention, and lessening the weight of the food that is on the plat,
the weigh-scale of the system will indicate and calculate the change in the weight, and the system and the computerized section will translate that weight to a calories amount, and add each additional amount that the user lessen from the plate, respectively to each specific type of food the user consume from the plate, to the total calories of the present meal displayed as the amount of calories that the user consume at the present meal, and
the source of power for operating the apparatus and system, might be a battery, external connection to electrical source, solar energy, or even might be a combination of the above.

2. The apparatus and system according to clams 1, wherein the plate is a multiple use plate that is designated to accommodate a one-time disposable plate one it.

3. The apparatus and system according to clams 1, wherein the plate is a multiple use plate that is designated to accommodate on it any regular plate that the meal will be put on it.

4. The apparatus and system according to clams 1, wherein if the person did not finish his meal, the computer would estimate the calories of the remaining or/and the calories of the food that the person actual ate.

5. The apparatus and system according to clams 1, wherein The computer would have a memory card and might have an option for remembering the calories of previous meals for calculation the total calories that the person ate for the last day, week, or even a month with the average of calories being consumed for a day.

6. The apparatus and system according to clams 1, wherein the sort and type of food taking out from the plate each and every time, requires a user to place the food he plans to eat on the plate and to press a button for entering the kind of food to the computer, the computer program then would automatically do all the calculations according to the kind of food and its weight, and
when there are few different kinds of dishes, the user will enter the computer the kind of food with each kind of food that the user placed on the plate, and, the computer would calculate the calories of each kind of food separate and then would add all the calculation to one total result, and the results of the number of calories of the total meal or after each kind of food optionally, be provided on a digital screen attached to the plate or optionally will be provided vocally by an attached audio speaker.

7. The apparatus and system according to clams 1, wherein Additional programs might be added so the computer after being provided with the required data of the user, i.e. sex, age, height and weight, might provide a program or advices for a preferred diet of that person. The computer program further with that data on the user and the calories of the meals that have been eaten might provide reports on the diet and even recommendations for continuing the diet.

8. The apparatus and system according to clams 1, wherein there might also be a USB or dick-on-key or a removable hardware connection to connect the plate to an external computer for download different information or programs for diets, or even for providing power source and charging the battery of the plate.

9. The apparatus and system according to clams 1, wherein Additional features might be added to the plate as for example additional weigh-scale and a dedicated place for a glass for calculating also the calories of different drinks and adding them to the calculation of the calories of the meals.

10. The apparatus and system according to clams 1, wherein this system of calculating the calories in a meal might also be implemented on a spoon or a fork calculating the calories of every bite, by providing the kind of food placed on the spoon and weighting it, and adding to the total calculation to provide a person with the information of how many calories he ate and when he reaches the amount he needs to eat by a vocal or visual alert.

11. The apparatus and system according to clams 7, wherein the computer might also be programmed to provide alert when the number of calories are over the suggested or planed by the user. The alert might be for example a red light or flashes of lights on the digital screen, or might be even a vocal alert with sentences that would remind and encourage the person to continue his diet and the importance in it.

12. A method for calculating the calories of a meal by a plate with built in weigh scale and dedicated software of a computer program, comprising:
a system for calculating the calories of a meal by a plate with built in weigh scale and dedicated software of a computer program to transfer the weight of each specific kinds of food to calories and to sum in the present time the total,
wherein, the calculation of the system is by the computerized section of the system that is dedicated with software's and weigh-scale, whereby,
in any time that the user is eating some amount of food, by taking that amount of and out of the plate of the present invention, and lessening the weight of the food that is on the plat,
the weigh-scale of the system will indicate and calculate the change in the weight and the system and the computerized section will translate that weight to a calories amount,
and add each additional amount that the user lessen from the plate, respectively to each specific type of food the user consume from the plate, to the total calories of the present meal displayed as the amount of calories that the user consume at the present meal, and
the sort and type of food taking out from the plate each and every time, requires a user to press a button for entering the kind of food to the computer or each and every time the user need to place the food he plans to eat on the plate and to press a button for entering the kind of food to the computer, the computer program then would automatically do all the calculations according to the kind of food and its weight, and
when there are few different kinds of dishes, the user will enter the computer the kind of food with each kind of food that the user placed on the plate or the type of food taking out from the plate, and, the computer would calculate the calories of each kind of food separate and then would add all the calculation to one total result, and
the results of the number of calories of the total meal or after each kind of food optionally, be provided on a digital screen attached to the plate or optionally will be provided vocally by an attached audio speaker.
